(19) United States
(12) Patent Application Publication
(10) Pub. No.: US 2010/0104497 A1
(43) Pub. Date: Apr. 29, 2010

(54) METHOD AND APPARATUS FOR PREPARING TUNGSTEN HEXAFLUORIDE USING A FLUIDIZED BED REACTOR

(75) Inventors: Hyang Ja JANG, Ulsan (KR); Jong Yool Yang, Ulsan (KR); Chul Ho Kim, Ulsan (KR); Young Gu Cho, Ulsan (KR); Jung Eun Lee, Ulsan (KR); Yuichi Ilkubo, West Lafayette, IN (US)

Correspondence Address: EGBERT LAW OFFICES, 412 MAIN STREET, 7TH FLOOR, HOUSTON, TX, 77002, US

(73) Assignee: FOOSUNG Co., Ltd., Ulsan (KR)

(21) Appl. No.: 12/388,859

(22) Filed: Feb. 19, 2009

(30) Foreign Application Priority Data
Oct. 28, 2008 (KR) 10-2008-0105681

(51) Int. Cl. C01B 9/08; F28D 21/00

(52) U.S. Cl. 423/489; 422/202

(57) ABSTRACT

Disclosed herein are a method of preparing tungsten hexafluoride (WF₆) gas by fluidizing tungsten powder with inert gas in a reactor and fluorinating the fluidized tungsten powder with fluorine (F₂) or nitrogen trifluoride (NF₃) gas, and an apparatus (including fluidized bed reactor) for carrying out the method. The fluidized bed reactor shows a reaction efficiency of higher than 99% when being used to prepare tungsten hexafluoride.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a method of preparing tungsten hexafluoride by fluidizing tungsten powder with inert gas in a fluidized bed and fluorinating the fluidized tungsten powder with a fluorinating agent and to an apparatus for carrying out the method. The fluidized reactor of the present invention can maximize the area of contact of tungsten with the fluorinating agent during the fluorination of tungsten, can efficiently control reaction temperature, and thus can greatly contribute to an improvement in conversion rate.

2. Description of Related Art Including Information Disclosed Under 37 CFR 1.97 and 37 CFR 1.98.

Tungsten hexafluoride (WF₆), which is a compound having a low boiling point (BP=19.5° C.), and a high specific gravity has the property of sublimating directly from the solid state the gaseous state.

Tungsten hexafluoride is used to deposit tungsten in semiconductor processes. In semiconductor processes, high-purity tungsten having no other metal impurities is required.

Korean Patent Registration No. 10-0727272 discloses a method of preparing tungsten hexafluoride by allowing metal tungsten to contact and react with fluorine or nitrogen trifluoride at a temperature of 250-950° C. in a horizontal pipe reactor.

U.S. Pat. No.3,185,543 discloses a process of preparing tungsten hexafluoride by allowing metal tungsten to contact and react with NOF.3HF at a temperature of 10-65° C. in a nickel tube reactor.

With respect to prior methods for preparing tungsten hexafluoride, in addition to the methods disclosed in the patent documents, a method of fluorinating tungsten hexachloride (WCl₆) with HF in a platinum vessel, a method of fluorinating tungsten hexachloride (WCl₆) with arsenic trifluoride (AsF₃) or antimony trifluoride (SbF₃), and the like are known.

Prior reactors for preparing tungsten hexafluoride are generally horizontal pipe reactors. A method of preparing tungsten hexafluoride using the horizontal pipe reactor comprises placing metal tungsten powder in the horizontal pipe reactor and fluorinating the metal tungsten with fluorine or nitrogen trifluoride.

3F₂+W→WF₆(−1721 kJ/mol at 298K)

2NF₃+W→WF₆+N₂

However, the fluorination reaction for preparing tungsten hexafluoride is an exothermic reaction which generates a large amount of heat. For this reason, in order to effectively control the reaction heat, a large heat transfer area which can maximize the dispersion of the reaction heat in the reactor is required. Also, fluorine or nitrogen trifluoride gas reacts only on the surface of fixed bed of tungsten powder, thus, if the contact area there between is limited, the efficiency of the reaction of tungsten with fluorine or nitrogen trifluoride will be reduced, such that unreacted gas will be discharged, and special process for treating the unreacted gas will be required. In order to increase the reaction efficiency, it is required to reduce the supply of reaction gas or to increase the surface area of the reactor. The present invention relates to a method and apparatus for preparing tungsten hexafluoride, which can maximize the area of contact of tungsten with fluorine or nitrogen trifluoride so as to obtain high reaction efficiency.

When the prior horizontal pipe reactor is used for the large-scale production of tungsten hexafluoride, there is a cost for treating a large amount of unreacted gas increases due to the decrease in reaction efficiency resulting from a limited contact area between tungsten and a fluorinating agent. It is difficult to distribute tungsten uniformly in the reactor. Moreover, when, for example, a metal screw mounted with a motor is used, the metal component of the screw is incorporated into tungsten. For these reasons, the horizontal pipe reactor and the metal screw are not suitable for use in a process for preparing high-purity tungsten hexafluoride.

### BRIEF SUMMARY OF THE INVENTION

The present invention allows tungsten having a specific gravity of 19.25 g/cm³ to be distributed uniformly in a reactor, thus maximizing the contact area between tungsten and reactant gas. Accordingly, the present invention provides a reaction system for preparing tungsten hexafluoride, which has a significantly reduced reactor volume, can more easily control reaction heat and significantly improves reaction efficiency.

The present invention relates to a method and apparatus for preparing tungsten hexafluoride, in which tungsten is fluidized in a reactor so as to maximize the efficiency of the reaction of tungsten with fluorine or nitrogen trifluoride.

Specifically, the present invention relates to a method for preparing tungsten hexafluoride, which comprises introducing tungsten powder into a closed reactor, feeding pressurized inert gas onto the tungsten powder to form a fluidized bed of tungsten powder, and continuously supplying tungsten powder and a pressurized gaseous fluorinating agent to the fluidized bed of tungsten powder so as to allow the tungsten powder to react with the fluorinating agent efficiently, and an apparatus for carrying out the method.

When gas of a given pressure is sprayed onto tungsten powder from the bottom of the reactor through a plurality of nozzles to fluidize the tungsten powder, the area of contact of the fluidized tungsten powder with fluorine or nitrogen trifluoride can be significantly increased. Thus, the efficiency of the reaction of the tungsten powder with fluorine or nitrogen trifluoride can be increased, the reaction heat can be easily dispersed and controlled, and the volume of the reactor can be reduced, leading to a decrease in material cost and an increase in the production of tungsten hexafluoride.

### BRIEF DESCRIPTION OF THE SEVERAL VIEWS OF THE DRAWINGS

The above and other objects, features and advantages of the present invention will be more clearly understood from the following detailed description taken in conjunction with the accompanying drawings.

FIG. 1 is a schematic view of a diagram showing a fluidized reactor of the present invention.

FIG. 2 is a schematic view of a diagram showing a continuous reaction process employing a fluidized reactor according to the present invention.

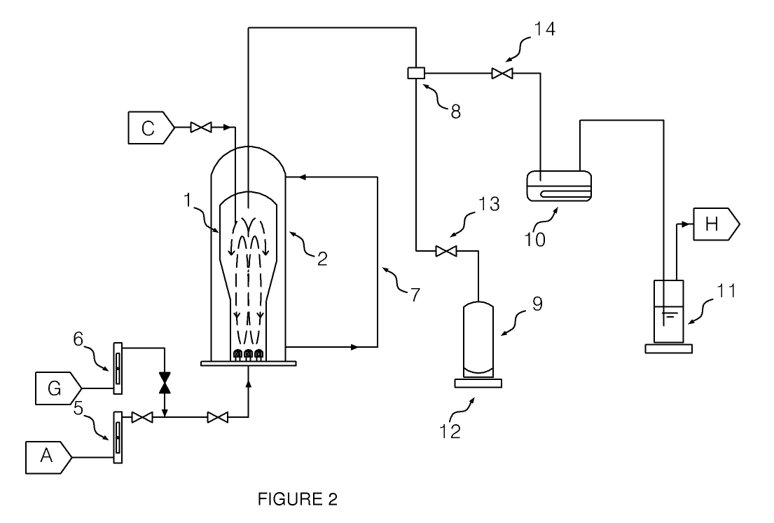

### DETAILED DESCRIPTION OF THE INVENTION

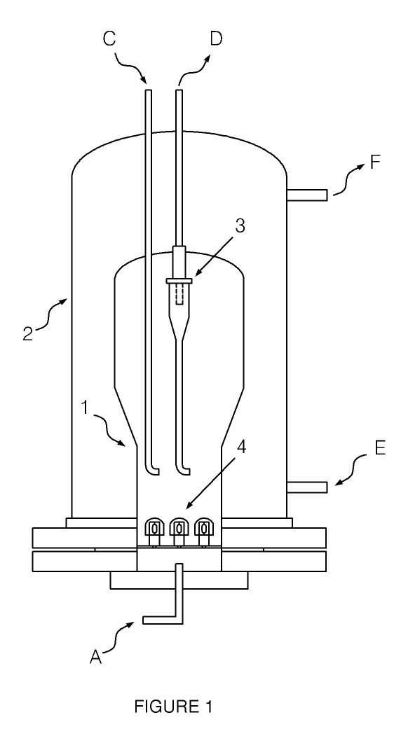

In the present invention, fine tungsten powder having a particle size of 0.1-100 μm is used. Tungsten has a very high specific gravity of 19.25 g/cm³, whereas powder tungsten has a low tap density of 0.2-10 g/cm³. Thus, when gas of a given pressure or more is sprayed onto the tungsten powder from the bottom of the reactor through a plurality of nozzles, the tungsten powder will float in the space of the reactor, and the reactor will be converted to a fluidized bed reactor system. After tungsten powder having a particle size of 0.1-1 00 μm is dried, it is introduced into the reactor through the tungsten supply tube C (FIG. 1). Any one inert gas selected from among nitrogen (N₂), helium (He) and argon (Ar) is used as an initial fluidizing gas, before a reactant gas is injected into the reactor. The inert gas which is injected into the reactor must be in a somewhat high pressure state, but when the fluidization of the tungsten powder starts to occur, the pressure of the inert gas rapidly decreases, such that the tungsten powder is distributed uniformly in the reactor and fluidized, even when the inert gas is injected at low pressure.

At this time, the high-purity inert gas is replaced with fluorine or nitrogen trifluoride, while fluorine or nitrogen trifluoride is allowed to react with the tungsten powder so as to produce tungsten hexafluoride. Herein, the area of contact between tungsten and fluorine or nitrogen trifluoride in the reactor is maximized to increase the efficiency of the reaction of tungsten with fluorine or nitrogen trifluoride, and thus the amount of unreacted gas from the reactor can be reduced to almost zero. As the tungsten powder in the reactor is fluidized, the reaction heat produced during the reaction is also efficiently dispersed. Thus, the control of the reaction heat can be easily achieved with cooling water which is circulated through the external jacket of the reactor. Also, it becomes easy to continuously supply the tungsten powder into the reactor and, in addition, tungsten hexafluoride can be prepared at the maximum reaction efficiency.

Hereinafter, the present invention will be described in detail with reference to a preferred embodiment.

As shown in FIG. 1, an apparatus for preparing tungsten hexafluoride comprises a cylindrical reactor 1, two or more gas supply nozzles 4 provided at the internal lower surface of the reactor 1, a tungsten supply pipe C and a tungsten hexafluoride gas discharge pipe D, which are exposed to the outside through the internal upper surface of the reactor 1, and a cooling water jacket surrounding the entire outer surface of the reactor 1. After the apparatus, as shown in FIG. 1, has been prepared, 1 kg of tungsten powder having a particle size of 0. 1-100 μm is introduced into the bottom of the cylindrical reactor 1 having a volume of 3 liters through the tungsten supply pipe C, and the temperature of cooling water in the cooling water jacket 12 is maintained at room temperature.

Then, nitrogen gas is supplied into the reactor 1 through the gas supply nozzles 4 at a flow rate of 5.5l /min and a pressure of 0.2 kg/cm² G, and the Tungsten powder is start to fluidized upward and downward in the reactor (1). When the tungsten powder is smoothly fluidized, nitrogen gas is switched to fluorine gas. The supply of the inert gas for initial fluidization is performed in order to make the fluorination of the tungsten powder start smoothly. The initial fluidization could occur through the supply of fluorine gas, but in this case, the reaction of tungsten with fluorine gas will rapidly occur and an undesirable reaction may occur due to the sudden and local generation of heat. Thus, when the tungsten powder is smoothly fluidized by the inert gas, fluorine gas is supplied into the reactor at a pressure of 0.2 kg/cm² G in the amount shown in Table 1 below. The pressure of the fluidizing gas used for fluidizing the tungsten metal powder is in the range of 0.2 to 1.0 kg/cm² G for a particle size of 0.1-100 μm, although it somewhat varies depending on the particle size of the tungsten powder.

The number of the gas supply nozzles 2 provided in the reactor 1 is preferably two or more in order to inject gases uniformly into the reactor 1. In the embodiment of the present invention, the number of the gas supply nozzles 4 provided in the reactor 1 is three. As the fluorination of the tungsten powder introduced at the initial stage proceeds, fresh tungsten powder is continuously supplied into the reactor through the tungsten supply pipe C. The tungsten powder supplied into the reactor through the tungsten supply pipe C is fluidized upward and downward in the reactor together with the already fluidized tungsten powder. At this time, the internal temperature of the reactor is maintained at 230-300° C. using the cooling water in the cooling water jacket 2. When fluorine gas is supplied onto the fluidized tungsten powder, the tungsten powder comes in contact with the fluorine gas in the fluidized bed while being fluorinated, and a gaseous mixture of tungsten hexafluoride and unreacted gas is venting from the reactor.

The tungsten hexafluoride (WF₆) produced from the reaction is collected in a gaseous state through a WF₆ gas discharge valve D and a WF₆ collecting valve 13, and then cooled in a condenser 8 so as to be condensed to the liquid state. Then, it is stored in a WF₆ storage tank 9.

At the middle portion of the tungsten hexafluoride gas discharge pipe D, a separator 3 is placed. In the embodiment of the present invention, the separator is a siphon trap. The separator is provided in order to separate WF₆ gas from the tungsten powder contained in the WF₆ gas.

Herein, the separated tungsten powder drops into the reactor, and the WF₆ gas is sent to the condenser 8 through the WF₆ gas discharge pipe D and the WF₆ collecting valve 13. Unreacted gas which has not been condensed in the condenser 8 is sent to an unreacted gas treatment unit 10 through a gas discharge valve 14. The unreacted gas collecting treatment unit 10 contains molten sulfur.

Some waste gas which has not been treated in the unreacted gas treatment unit 10 is sent to and completely scrubbed in an alkali scrubber 11.

The reaction rate between tungsten powder and fluorine gas can be calculated by measuring the consumption of the fluorine gas through a fluorine gas flowmeter 5 and measuring the weight of the produced tungsten hexafluoride.

In the present invention, NF₃ may also be used instead of F₂ gas as a fluorinating agent.

The ratio of unreacted gas to the supplied gas is determined by measuring the weight of the produced tungsten hexafluoride based on the theoretical weight of the tungsten hexafluoride from supplied total amount of fluorine gas.

Table 1 below shows results for the production rate of WF₆ and the amount of unreacted fluorine gas with the reaction time.

TABLE 1
Production rate (%) with the passage of reaction time

| | Reaction time (hr) | | |
|---|---|---|---|
| | 1 | 50 | 100 |
| Amount of supplied fluorine | 350 | 350 | 350 |
| gas (g/hr) | | | |
| Reaction temperature | 230-270° C. | 230-270° C. | 230-270° C. |
| WF₆ selectivity (%) | 99.2 | 98.0 | 99.0 |
| Ratio (%) of unreacted | 0.8 | 1.1 | 1.0 |
| fluorine gas | | | |

As shown in Table 1 above, in the experiment employing the fluidized bed reactor system, there was little or no change in the production rate of WF₆ even with the passage of reaction time, and the ratio of unreacted F₂ gas to the supplied F₂ gas was very low.

As described above, the inventive method of preparing tungsten hexafluoride by allowing metal tungsten to react with fluorine or nitrogen trifluoride in this inventive fluidized bed reactor enables tungsten hexafluoride to be prepared with high yield and high purity using a relatively small size reactor.

Although the preferred embodiment of the present invention has been described for illustrative purposes, those skilled in the art will appreciate that various modifications, additions and substitutions are possible, without departing from the scope and spirit of the invention as disclosed in the accompanying claims.

1. A method of preparing tungsten hexafluoride (WF₆) by allowing tungsten to contact and react with a fluorinating agent in a fluidized bed reactor, the method comprising the steps of:
introducing tungsten powder into a closed reactor;
feeding pressurized inert gas onto said tungsten powder to form a fluidized bed in the reactor; and
continuously switching to a pressurized gaseous fluorinating agent, the supplied tungsten powder reacting with the fluorinating agent in the fluidized bed.

2. The method of claim 1, wherein the tungsten powder has a particle size of 0.1-100 μm, wherein the inert gas is selected from the group consisting of nitrogen, argon and helium, and wherein the fluorinating agent is comprised of fluorine or nitrogen trifluoride.

3. The method of claim 1, wherein the inert gas and the fluorinating agent are supplied at a pressure of 0.2-10 kg/cm² G.

4. An apparatus of preparing tungsten hexafluoride by allowing tungsten to contact and react with a fluorinating agent, the apparatus comprising:
a cylindrical reactor;
two or more gas supply nozzles provided at the internal lower surface of the reactor;
a tungsten powder supply pipe and a tungsten hexafluoride gas discharge pipe, which are exposed to the outside through the internal upper surface of the reactor; and
a cooling water jacket surrounding the outer surface of the reactor.
